(19) United States
(12) Patent Application Publication
(10) Pub. No.: US 2024/0136535 A1
(43) Pub. Date: Apr. 25, 2024

(54) ELECTROCHEMICAL DEVICE AND ELECTRONIC DEVICE

(71) Applicant: Ningde Amperex Technology Limited, Ningde (CN)

(72) Inventors: Changchao DU, Ningde (CN); Kefei WANG, Ningde (CN); Feng ZHOU, Ningde (CN); Qingwen ZHANG, Ningde (CN)

(73) Assignee: Ningde Amperex Technology Limited, Ningde (CN)

(21) Appl. No.: 18/539,272

(22) Filed: Dec. 14, 2023

Related U.S. Application Data
(63) Continuation of application No. PCT/CN2022/074355, filed on Jan. 27, 2022.

(30) Foreign Application Priority Data
Jun. 14, 2021 (CN) 202110661489.7

(51) Int. Cl. H01M 4/66; H01M 4/133; H01M 10/0525

(52) U.S. Cl. CPC H01M 4/663; H01M 4/133; H01M 4/667; H01M 10/0525; H01M 2004/027

(57) ABSTRACT

An electrochemical device includes a negative electrode sheet. The negative electrode sheet includes a current collector, a first coating layer, and a second coating layer. The first coating layer is located between the current collector and the second coating layer. The second coating layer includes a negative active material. The first coating layer includes a conductive carbon material. The conductive carbon material includes at least one of carbon nanotubes or graphene. Based on a mass of the first coating layer, a mass percent of the conductive carbon material is 20% to 60%. The main material of the first coating layer is at least one of carbon nanotubes or graphene.

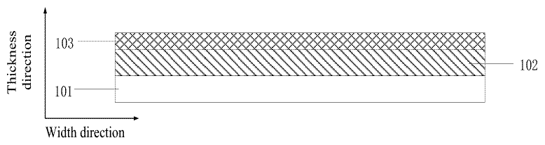

### CROSS-REFERENCE TO RELATED APPLICATIONS

This application is a continuation of International Patent Application PCT/CN2022/074355, filed on Jan. 27, 2022, which claims the benefit of priority of Chinese patent application 202110661489.7, filed on Jun. 15, 2021, the contents of each are incorporated herein by reference in its entirety.

### TECHNICAL FIELD

This application relates to the field of electronic technology, and in particular, to an electrochemical device and an electronic device.

### BACKGROUND

With the wide use of electrochemical devices (such as a lithium-ion battery) in various electronic products, users have posed higher requirements on an energy density, rate performance, and cycle performance of the electrochemical devices. Generally, an active material with a higher gram capacity may be used to increase the energy density of the electrochemical devices. However, some active materials with a high gram capacity are relatively rigid, and are prone to cause damage to a current collector. Therefore, further improvements are expected.

### SUMMARY

Embodiments of this application provide an electrochemical device. The electrochemical device includes a negative electrode sheet. The negative electrode sheet includes a current collector, a first coating layer and a second coating layer disposed on a surface of the current collector. The first coating layer is located between the current collector and the second coating layer. The first coating layer includes a conductive carbon material. The conductive carbon material includes at least one of carbon nanotubes or graphene. Based on a mass of the first coating layer, a mass percent of the conductive carbon material is 20% to 60%. The second coating layer includes a negative active material.

In some embodiments, the negative active material includes at least one of hard carbon, artificial graphite, natural graphite, or oxide of silicon. In some embodiments, a thickness of the first coating layer is 0.3 μm to 2 μm. In some embodiments, a coating rate of the first coating layer is greater than or equal to 60%. In some embodiments, the first coating layer and the second coating layer each further include a dispersant. The dispersant includes at least one of carboxymethyl cellulose salt, polyacrylic acid sodium salt, polyethylene glycol, or polyethylene oxide. In some embodiments, based on the mass of the first coating layer, a mass percent of the dispersant is 1% to 10%, and/or, based on a mass of the second coating layer, a mass percent of the dispersant is 1% to 10%. In some embodiments, the first coating layer and the second coating layer each further include a binder. The binder includes at least one of polyvinylidene fluoride, polyvinylidene difluoride, poly(vinylidene difluoride-co-hexafluoropropylene), styrene-butadiene rubber, styrene-acrylic latex, sodium carboxymethyl cellulose, polyacrylic acid sodium salt, polyethylene oxide, or polyvinyl alcohol. In some embodiments, based on the mass of the first coating layer, a mass percent of the binder is 35% to 75%, and/or, based on a mass of the second coating layer, a mass percent of the binder is 1% to 10%. In some embodiments, the negative active material is hard carbon. Based on a mass of the second coating layer, a mass percent of the hard carbon is 95% to 99%.

An embodiment of this application further provides an electronic device, including the electrochemical device.

In the embodiments of this application, the main material of the first coating layer is at least one of carbon nanotubes or graphene. The mass percent of carbon nanotubes and graphene in the first coating layer is 20% to 60%. On the one hand, the carbon nanotubes and the graphene possess a relatively large elastic modulus, thereby mitigating the damage caused by the relatively rigid negative active material in the second coating layer to the current collector, enhancing the bonding of the active material to the current collector, and improving cycle characteristics of an electrode sheet. On the other hand, the carbon nanotubes and the graphene possess a relatively low cycle expansion rate, thereby helping to mitigate the cycle expansion of the negative electrode sheet on the whole.

### BRIEF DESCRIPTION OF DRAWINGS

FIGURE shows a cross-sectional view of a negative electrode sheet sectioned in a plane defined by a depth direction and a width direction according to some embodiments of this application.

### DETAILED DESCRIPTION

The following embodiments enable a person skilled in the art to understand this application more comprehensively, but without limiting this application in any way.

Some embodiments of this application provide an electrochemical device. The electrochemical device includes a negative electrode sheet. In some embodiments, FIGURE shows a cross-sectional view of the negative electrode sheet sectioned in a plane defined by a depth direction and a width direction according to some embodiments of this application. As shown in the FIGURE, the negative electrode sheet includes a current collector 101, a first coating layer 102, and a second coating layer 103. The first coating layer 102 is located between the current collector 101 and the second coating layer 103. Understandably, the first coating layer 102 and the second coating layer 103 may be located on a single side of the current collector 101, or may be located on both sides of the current collector 101.

In some embodiments, the second coating layer 103 includes a negative active material. In some embodiments, the first coating layer 102 includes a conductive carbon material. The conductive carbon material includes at least one of carbon nanotubes or graphene. In some embodiments, based on the mass of the first coating layer 102, the mass percent of the conductive carbon material is 20% to 60%. The main material of the first coating layer 102 is at least one of carbon nanotubes or graphene. On the one hand, the carbon nanotubes and the graphene possess a relatively large elastic modulus, thereby mitigating the damage caused by the relatively rigid negative active material in the second coating layer to the current collector. On the other hand, the carbon nanotubes and the graphene possess a relatively low cycle expansion rate, thereby helping to mitigate the cycle expansion of the negative electrode sheet on the whole.

In addition, if the mass percent of the conductive carbon material in the first coating layer 102 is excessively low, the sufficient mitigation of the damage caused by the negative active material in the second coating layer 103 to the current collector 101 will be adversely affected. If the mass percent of the conductive carbon material in the first coating layer 102 is excessively high, the mass percent of the binder usually needs to be reduced, thereby being detrimental to the exertion of the bonding performance of the first coating layer 102 and prone to cause expansion of the first coating layer 102 during cycles. In some embodiments, based on the mass of the first coating layer 102, the mass percent of the conductive carbon material is 30% to 50%. In some embodiments, based on the mass of the first coating layer 102, the mass percent of the conductive carbon material is 20%, 25%, 30%, 35%, 40%, 45%, 50%, 55%, 60%, or in a range formed by any two thereof. When the mass percent of the conductive carbon material falls within the above range, the damage caused by the negative active material in the second coating layer 103 to the current collector 101 is well mitigated, and the first coating layer 102 achieves high bonding performance.

In some embodiments, the negative active material includes at least one of hard carbon, artificial graphite, natural graphite, or oxide of silicon. The gram capacity of such negative active materials is relatively high, thereby being conducive to increasing the energy density of the electrochemical device. Especially, the hard carbon, whose gram capacity is higher than that of graphite, may further increase the energy density of the electrochemical device compared with graphite. However, the rigidity of the hard carbon is relatively high, and is prone to cause damage to the current collector 101 during cold pressing of the electrode sheet. Consequently, the second coating layer 103 may hardly be bonded firmly to the current collector 101 during cycles. The protection by the carbon nanotubes and/or graphene in the first coating layer 102 may mitigate the damage caused by the hard carbon to the current collector 101, thereby improving the cycle characteristics of the electrode sheet.

In some embodiments, the thickness of the first coating layer 102 is 0.3 μm to 2 μm. If the thickness of the first coating layer 102 is excessively small, the effect of the first coating layer 102 in increasing the adhesion between the current collector 101 and the second coating layer 103 is relatively limited, and the second coating layer 103 is prone to detach. If the thickness of the first coating layer 102 is excessively large, the electronic conductivity of the first coating layer 102 will deteriorate, the lithium plating of the negative electrode sheet will be aggravated, and the increase of the energy density of the electrochemical device will be adversely affected. In some embodiments, the thickness of the first coating layer 102 is 0.5 μm to 1.5 μm. In some embodiments, the thickness of the first coating layer 102 is 0.3 μm, 0.5 μm, 0.8 μm, 1 μm, 1.3 μm, 1.5 μm, 1.8 μm, 2 μm, or in a range formed by any two thereof. When the thickness of the first coating layer 102 falls within the above range, the effect of bonding between the current collector 101 and the second coating layer 103 may be improved, and the hazard of lithium plating of the negative electrode sheet may be mitigated.

In some embodiments, the thickness of the first coating layer 102 may be measured by the following method: Testing a polished cross section of the coating layer by using a scanning electron microscope, making a straight line perpendicular to the plane of the current collector so that the vertical line intersects an upper edge and a lower edge of the coating layer at two points respectively, and measuring the distance between the two points as the thickness of the coating layer; selecting 100 thickness values of the coating layer randomly according to the foregoing method, removing the largest 25 thickness values and the smallest 25 thickness values, and using an average value of the remaining 50 thickness values as the thickness of the coating layer. Understandably, this method is merely exemplary, and the thickness may be measured according to other appropriate methods.

In some embodiments, the coating rate of the first coating layer 102 is greater than or equal to 60%. The coating rate is a percentage of a coating area of the first coating layer 102 in the area of the current collector 101 within a unit area of 1 mm² on a single side of the current collector 101. If the coating rate of the first coating layer 102 is excessively low, the first coating layer 102 will be adversely affected in providing sufficient protection for the current collector 101. In some embodiments, the coating rate of the first coating layer 102 is 60% to 90%. In some embodiments, the coating rate of the first coating layer 102 is 70% to 80%. In some embodiments, the coating rate of the first coating layer 102 is 60%, 65%, 70%, 75%, 80%, 85%, 90%, or in a range formed by any two thereof. With the current collector 101 being partly coated with the first coating layer 102 to some extent, the overall roughness of the first coating layer 102 is increased conveniently, thereby facilitating good bonding between the current collector 101 and the second coating layer 103.

In some embodiments, the first coating layer 102 and the second coating layer 103 each further include a dispersant. The dispersant includes at least one of carboxymethyl cellulose salt, polyacrylic acid sodium salt, polyethylene glycol, or polyethylene oxide. In some embodiments, the carboxymethyl cellulose salt may include at least one of sodium carboxymethyl cellulose or lithium carboxymethyl cellulose. In some embodiments, based on the mass of the first coating layer 102, the mass percent of the dispersant is 1% to 10%; based on the mass of the second coating layer 103, the mass percent of the dispersant is 1% to 10%. In some embodiments, the mass percent of the dispersant in the first coating layer 102 is 3% to 8%, and the mass percent of the dispersant in the second coating layer 103 is 3% to 8%. In some embodiments, the mass percent of the dispersant in the first coating layer 102 is 5% to 7%, and the mass percent of the dispersant in the second coating layer 103 is 5% to 7%. In some embodiments, the mass percent of the dispersant in the first coating layer 102 is 1%, 2%, 3%, 4%, 5%, 6%, 7%, 8%, 9%, 10% or in a range formed by any two thereof, and the mass percent of the dispersant in the second coating layer 103 is 1%, 2%, 3%, 4%, 5%, 6%, 7%, 8%, 9%, 10% or in a range formed by any two thereof. Understandably, the mass percent of the dispersant in the first coating layer 102 may be set independently of the mass percent of the dispersant in the second coating layer 103. If the mass percent of the dispersant is excessively low, homogeneous dispersion of the materials in the first coating layer 102 and the second coating layer 103 will be adversely affected. If the mass percent of the dispersant is excessively high, the mass percent of the conductive carbon material, the negative active material, or binder needs to be reduced. This adversely affects the improvement of performance of protection by the first coating layer 102 for the current collector 101, adversely affects the improvement of performance of bonding between the current collector 101 and the second coating layer 103, and adversely affects the increase of the energy density of the electrochemical device.

In some embodiments, the first coating layer 102 and the second coating layer 103 each further include a binder. The binder includes at least one of polyvinylidene fluoride, polyvinylidene difluoride, poly(vinylidene difluoride-co-hexafluoropropylene), styrene-butadiene rubber, styrene-acrylic latex, sodium carboxymethyl cellulose, polyacrylic acid sodium salt, polyethylene oxide, or polyvinyl alcohol. In some embodiments, based on the mass of the first coating layer 102, the mass percent of the binder is 35% to 75%. In some embodiments, the mass percent of the binder in the first coating layer 102 is 45% to 65%. In some embodiments, the mass percent of the binder in the first coating layer 102 is 35%, 40%, 45%, 50%, 55%, 60%, 65%, 70%, 75%, or in a range formed by any two thereof. If the mass percent of the binder in the first coating layer 102 is excessively low, the exertion of the bonding performance of the first coating layer 102 will be adversely affected. If the mass percent of the binder in the first coating layer 102 is excessively high, the electrical performance of the first coating layer 102 will deteriorate. In some embodiments, based on the mass of the second coating layer 103, the mass percent of the binder is 1% to 10%. In some embodiments, the mass percent of the binder in the second coating layer 103 is 3% to 8%. In some embodiments, the mass percent of the binder in the second coating layer 103 is 5% to 7%. In some embodiments, the mass percent of the binder in the second coating layer 103 is 1%, 2%, 3%, 4%, 5%, 6%, 7%, 8%, 9%, 10%, or in a range formed by any two thereof. If the mass percent of the binder in the second coating layer 103 is excessively low, the bonding between the materials in the second coating layer 103 will be adversely affected. If the mass percent of the binder in the second coating layer 103 is excessively high, the mass percent of the negative active material usually needs to be reduced, thereby being detrimental to the increase of the energy density of the electrochemical device.

In some embodiments, the negative active material is hard carbon. The gram capacity of the hard carbon is greater than that of graphite. The hard carbon serving as a negative active material helps to increase the energy density of the electrochemical device. In addition, the cycle expansion rate of hard carbon is lower than that of graphite. The hard carbon serving as a negative active material helps to mitigate the cycle expansion of the electrochemical device. In some embodiments, based on the mass of the second coating layer 103, the mass percent of the hard carbon is 95% to 99%. By setting the mass percent of the hard carbon to a relatively high value, the energy density of the electrochemical device may be increased conveniently. However, an excessive mass percent of the hard carbon in the second coating layer 103 is inadvisable, and leads to an excessively low mass percent of the binder in the second coating layer 103, thereby affecting the stable bonding between various materials in the second coating layer 103.

In some embodiments, the conductive carbon material includes carbon nanotubes. D₅₀ of the carbon nanotubes is 10 μm to 20 μm. D₅₀ of the carbon nanotubes is an average particle diameter of the carbon nanotubes, and may be obtained by averaging the particle diameters per unit area that are measured by a scanning electron microscope. If D₅₀ of the carbon nanotubes is excessively small, the mitigation of the damage caused by the active material in the second coating layer 103 to the current collector 101 will be adversely affected. If D₅₀ of the carbon nanotubes is excessively large, the improvement of the rate performance of the electrochemical device will be adversely affected. In some embodiments, based on the mass of the first coating layer, the mass percent of the carbon nanotubes is 30% to 60%. If the mass percent of the carbon nanotubes in the first coating layer 102 is excessively low, the sufficient mitigation of the damage caused by the negative active material in the second coating layer 103 to the current collector 101 will be adversely affected. If the mass percent of the carbon nanotubes in the first coating layer 102 is excessively high, the mass percent of the binder usually needs to be reduced, thereby being detrimental to the exertion of the bonding performance of the first coating layer 102 and the exertion of the conduction performance

In some embodiments, the current collector 101 of the negative electrode sheet may be at least one of a copper foil, a nickel foil, or a carbon-based current collector.

In some embodiments, the electrochemical device may further include a positive electrode sheet and a separator. The separator is disposed between the positive electrode sheet and the negative electrode sheet. In some embodiments, the positive electrode sheet includes a positive active material layer. The positive active material layer includes a positive active material. In some embodiments, the positive active material includes at least one of lithium cobalt oxide, lithium iron phosphate, lithium iron manganese phosphate, sodium iron phosphate, lithium vanadium phosphate, sodium vanadium phosphate, lithium vanadyl phosphate, sodium vanadyl phosphate, lithium vanadium oxide, lithium manganese oxide, lithium nickel oxide, lithium nickel cobalt manganese oxide, lithium-rich manganese-based material, or lithium nickel cobalt aluminum oxide. In some embodiments, the positive active material layer may further include a conductive agent. In some embodiments, the conductive agent in the positive active material layer may include at least one of conductive carbon black, Ketjen black, graphite flakes, graphene, carbon nanotubes, or carbon fiber. In some embodiments, the positive active material layer may further include a binder. The binder in the positive active material layer may include at least one of carboxymethyl cellulose (CMC), polyacrylic acid, polyvinylpyrrolidone, polyaniline, polyimide, polyamideimide, polysiloxane, styrene butadiene rubber, epoxy resin, polyester resin, polyurethane resin, or polyfluorene. In some embodiments, a mass ratio of the positive active material, the conductive agent, and the binder in the positive active material layer may be (80 to 99):(0.1 to 10):(0.1 to 10). In some embodiments, the thickness of the positive active material layer may be 10 μm to 500 μm. Understandably, what is described above is merely an example, and the positive active material layer of the positive electrode sheet may adopt any other appropriate material, thickness, and mass ratio.

In some embodiments, the current collector of the positive electrode sheet may be an aluminum foil, or may be another current collector commonly used in the art. In some embodiments, the thickness of the current collector of the positive electrode sheet may be 1 μm to 200 μm. In some embodiments, the positive active material layer may be coated on merely a partial region of the current collector of the positive electrode sheet.

In some embodiments, the separator includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially, the polyethylene and the polypropylene are highly effective in preventing short circuits, and improve stability of the battery through a turn-off effect. In some embodiments, the thickness of the separator is within a range of approximately 5 μm to 50 μm.

In some embodiments, a surface of the separator may further include a porous layer. The porous layer is disposed on at least one surface of the substrate of the separator. The porous layer includes inorganic particles and a binder. The inorganic particles are at least one selected from aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, a diameter of a pore of the separator is within a range of approximately 0.01 μm to 1 μm. The binder in the porous layer is at least one selected from polyvinylidene difluoride, a vinylidene difluoride-hexafluoropropylene copolymer, a polyamide, polyacrylonitrile, polyacrylic ester, polyacrylic acid, sodium polyacrylate, sodium carboxymethyl cellulose, polyvinylpyrrolidone, polyvinyl ether, poly methyl methacrylate, polytetrafluoroethylene, or polyhexafluoropropylene. The porous layer on the surface of the separator may improve heat resistance, oxidation resistance, and electrolyte infiltration performance of the separator, and enhance adhesion between the separator and the electrode sheet.

In some embodiments of this application, the electrode assembly of the electrochemical device is a jelly-roll electrode assembly, a stacked electrode assembly, or a folded electrode assembly. In some embodiments, the positive electrode sheet and/or negative electrode sheet of the electrochemical device may be a multi-layer structure formed by winding or stacking, or may be a single-layer structure formed by stacking a single layer of positive electrode sheet, a separator, and a single layer of negative electrode sheet.

In some embodiments, the electrochemical device includes, but is not limited to, a lithium-ion battery. In some embodiments, the electrochemical device may further include an electrolyte. The electrolyte may be one or more of a gel electrolyte, a solid-state electrolyte, or an electrolytic solution. The electrolytic solution includes a lithium salt and a nonaqueous solvent. The lithium salt is one or more selected from LiPF₆, LiBF₄, LiAsF₆, LiC₁₀₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆ because it is of a high ionic conductivity and may improve cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxy ethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

In some embodiments of this application, using a lithium-ion battery as an example, the lithium-ion battery is prepared by: winding or stacking the positive electrode sheet, the separator, and the negative electrode sheet sequentially into an electrode assembly, putting the electrode assembly into a package such as an aluminum plastic film ready for sealing, injecting an electrolytic solution, and performing chemical formation and sealing; Then a performance test is performed on the prepared lithium-ion battery.

A person skilled in the art understands that the method for preparing the electrochemical device (for example, the lithium-ion battery) described above is merely an example. To the extent not departing from the content disclosed herein, other methods commonly used in the art may be used.

An embodiment of this application further provides an electronic device containing the electrochemical device. The electronic device according to the embodiments of this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game console, a watch, a power tool, a flashlight, a camera, a large household battery, a lithium-ion capacitor, and the like.

Some specific embodiments and comparative embodiments are enumerated below to give a clearer description of this application, using a lithium-ion battery as an example.

### Embodiment 1

Preparing a positive electrode sheet: Mixing lithium cobalt oxide as a positive active material, conductive carbon black (Super P), and polyvinylidene difluoride (PVDF) at a weight ratio of 97:1.4:1.6, adding N-methyl pyrrolidone (NMP) as a solvent, and stirring evenly. Coating a positive current collector aluminum foil with the slurry (with a solid content of 72 wt %) evenly until the thickness of the coating reaches 80 μm. Drying the aluminum foil at 85° C., then performing cold pressing, cutting, and slitting, and then drying the aluminum foil under an 85° C. vacuum condition for 4 hours to obtain a positive electrode sheet.

Preparing a negative electrode sheet: Dissolving carbon nanotubes, sodium carboxymethyl cellulose (CMC), and styrene butadiene rubber (SBR) serving as a binder at a weight ratio of 50:5:45 in deionized water to form a first coating slurry. Using a 10 μm-thick copper foil as a current collector of the negative electrode sheet, coating the current collector of the negative electrode sheet with the first coating slurry at a coating rate of 90% until the thickness of the coating reaches 0.5 μm, and drying to obtain a first coating layer.

Dissolving hard carbon, sodium carboxymethyl cellulose (CMC), and the SBR binder at a weight ratio of 96:2:2 in deionized water to form a second coating slurry. Applying the second coating layer onto the current collector coated with the first coating layer, and performing drying and cutting to obtain a negative electrode sheet.

Preparing a separator: Using 8 μm-thick polyethylene (PE) as a substrate of the separator, coating both sides of the substrate of the separator with a 2 μm-thick aluminum oxide ceramic layer. Finally, coating a polyvinylidene difluoride (PVDF) binder in an amount 2.5 mg/cm 2 onto both sides that have been coated with the ceramic layer, and performing drying.

Preparing an electrolytic solution: Adding LiPF₆ into a nonaqueous organic solvent in an environment in which a water content is less than 10 ppm, where the mass ratio between ingredients of the nonaqueous organic solvent is ethylene carbonate (EC):propylene carbonate (PC)=50:50, and the concentration of the LiPF₆ is 1.15 mol/L. Mixing the solution evenly to obtain an electrolytic solution.

Preparing a lithium-ion battery: stacking the positive electrode sheet, the separator, and the negative electrode sheet sequentially in such a way that the separator is located between the positive electrode sheet and the negative electrode sheet to serve a function of separation, and winding the stacked materials to obtain an electrode assembly; Putting the electrode assembly in an aluminum plastic film that serves as an outer package, dehydrating the electrode assembly under 80° C., injecting the electrolytic solution, and performing sealing; and performing steps such as chemical formation, degassing, and edge trimming to obtain a lithium-ion battery.

Testing the Cycle Expansion Rate:

Putting a lithium-ion battery into a 45° C.±2° C. thermostat, leaving the battery to stand for 2 hours, charging the battery at a 1 C rate until the voltage reaches 4.48 V, and then charging the battery at a constant voltage of 4.48 V until the current reaches 0.05 C. Then discharging the battery at a 1 C rate until the voltage reaches 3.0 V, thereby completing one cycle. Testing the battery by repeating the cycles. Upon completion of 800 cycles, measuring the thickness of the lithium-ion battery by using a thickness gauge, and recording the thickness changes. Taking 4 lithium-ion batteries for each group, obtaining an average thickness value of the batteries, and calculating the cycle expansion rate of the lithium-ion battery.

Cycle expansion rate=(thickness of the lithium-ion battery after 800 cycles/thickness of the chemically formed lithium-ion battery−1)×100%.

The steps in the embodiments and comparative embodiments are the same as those in Embodiment 1 except changed parameter values. The specific changed parameter values are shown in the following table.

Table 1 shows parameters and evaluation results in Embodiments 1 to 21 and Comparative Embodiments 1 to 3. In Embodiments 2 to 3, the content of the conductive carbon material in the first coating layer is different from that in Embodiment 1. In Embodiments 4 to 6, the type and content of the conductive carbon material in the first coating layer, the thickness and coating rate of the first coating layer, and the content of each material in the second coating layer are different from those in Embodiment 1. In Embodiment 7, the content of the dispersant and the binder in the first coating layer as well as the content of each material in the second coating layer are different from those in Embodiment 1. In Embodiments 8 to 10, the thickness of the first coating layer is different from that in Embodiment 1. In Embodiments 11 to 12, the thickness and coating rate of the first coating layer are different from those in Embodiment 1. In Embodiments 13 and 14, the thickness of the first coating layer and the type of material of the second coating layer are different from those in Embodiment 1. In Embodiments 15 to 17, the type and content of the conductive carbon material in the first coating layer, the thickness and coating rate of the first coating layer, and the content of each material in the second coating layer are different from those in Embodiment 1. In Embodiments 18 and 19, the types and content of the conductive carbon materials in the first coating layer, the thickness and coating rate of the first coating layer, and the content of each material in the second coating layer are different from those in Embodiment 1. In Embodiments 20 and 21, the type and content of the conductive carbon materials in the first coating layer, the thickness of the first coating layer, and the type and content of the second coating layer are different from those in Embodiment 1. In Comparative Embodiment 1, the type of the conductive carbon materials in the first coating layer is different from that in Embodiment 1. In Comparative Embodiment 2, the type and content of the conductive carbon materials in the first coating layer, the thickness and coating rate of the first coating layer, and the content of each material in the second coating layer are different from those in Embodiment 1. In Comparative Embodiment 3, no first coating layer exists.

TABLE 1

| | Conductive | | | | | | | | |
|---|---|---|---|---|---|---|---|---|---|
| | carbon | | | | | | | | |
| | material | Mass | Mass | | | Active | Mass | Mass | |
| | and | percent | percent | | | material | percent | percent | Cycle |
| | the mass | of | of | | | and the | of | of | expansion |
| | percent | dispersant | binder | Thickness | | mass | dispersant | binder | rate |
| | thereof | CMC | SBR | of the | Coating | percent | CMC | SBR | after |
| | in the | in the | in the | first | rate of | in the | in the | in the | 800 |
| | first | first | first | coating | the first | second | second | second | cycles |
| | coating | coating | coating | layer | coating | coating | coating | coating | under |
| Embodiment | layer | layer | layer | (μm) | layer | layer | layer | layer | 45° C. |
| 1 | 50.0% | 5.00% | 45.00% | 0.5 | 90% | 96% | 2.00% | 2.00% | 6.0% |
| | CNT | | | | | hard | | | |
| | | | | | | carbon | | | |
| 2 | 30.0% | 5.00% | 65.00% | 0.5 | 90% | 96% | 2.00% | 2.00% | 6.4% |
| | CNT | | | | | hard | | | |
| | | | | | | carbon | | | |
| 3 | 60.0% | 5.00% | 35.00% | 0.5 | 90% | 96% | 2.00% | 2.00% | 6.6% |
| | CNT | | | | | hard | | | |
| | | | | | | carbon | | | |
| 4 | 20.0% | 5.00% | 75.00% | 1 | 85% | 97% | 2.00% | 1.00% | 6.5% |
| | graphene | | | | | hard | | | |
| | | | | | | carbon | | | |
| 5 | 40.0% | 5.00% | 55.00% | 1 | 85% | 97% | 2.00% | 1.00% | 5.8% |
| | graphene | | | | | hard | | | |
| | | | | | | carbon | | | |
| 6 | 60.0% | 5.00% | 35.00% | 1 | 85% | 97% | 2.00% | 1.00% | 6.2% |
| | graphene | | | | | hard | | | |
| | | | | | | carbon | | | |
| 7 | 50.0% | 7.00% | 43.00% | 0.5 | 90% | 98% | 1.00% | 1.00% | 6.1% |
| | CNT | | | | | hard | | | |
| | | | | | | carbon | | | |
| 8 | 50.0% | 5.00% | 45.00% | 0.8 | 90% | 96% | 2.00% | 2.00% | 5.8% |
| | CNT | | | | | hard | | | |
| | | | | | | carbon | | | |
| 9 | 50.0% | 5.00% | 45.00% | 1.5 | 90% | 96% | 2.00% | 2.00% | 5.4% |
| | CNT | | | | | hard | | | |
| | | | | | | carbon | | | |
| 10 | 50.0% | 5.00% | 45.00% | 2 | 90% | 96% | 2.00% | 2.00% | 5.0% |
| | CNT | | | | | hard | | | |
| | | | | | | carbon | | | |
| 11 | 50.0% | 5.00% | 45.00% | 0.8 | 70% | 96% | 2.00% | 2.00% | 6.6% |
| | CNT | | | | | hard | | | |
| | | | | | | carbon | | | |
| 12 | 50.0% | 5.00% | 45.00% | 0.8 | 80% | 96% | 2.00% | 2.00% | 6.2% |
| | CNT | | | | | hard | | | |
| | | | | | | carbon | | | |
| 13 | 50.0% | 5.00% | 45.00% | 0.8 | 90% | 96% | 2.00% | 2.00% | 12.0% |
| | CNT | | | | | natural | | | |
| | | | | | | graphite | | | |
| 14 | 50.0% | 5.00% | 45.00% | 0.8 | 90% | 96% | 2.00% | 2.00% | 15.0% |
| | CNT | | | | | oxide | | | |
| | | | | | | of silicon | | | |
| | | | | | | (SiOₓ, | | | |
| | | | | | | 0.5 ≤ x ≤ 1.5) | | | |
| 15 | 40.0% | 5.00% | 55.00% | 0.6 | 85% | 97% | 2.00% | 1.00% | 6.6% |
| | graphene | | | | | hard | | | |
| | | | | | | carbon | | | |
| 16 | 40.0% | 5.00% | 55.00% | 1.2 | 85% | 97% | 2.00% | 1.00% | 5.4% |
| | graphene | | | | | hard | | | |
| | | | | | | carbon | | | |
| 17 | 40.0% | 5.00% | 55.00% | 1.8 | 85% | 97% | 2.00% | 1.00% | 5.0% |
| | graphene | | | | | hard | | | |
| | | | | | | carbon | | | |
| 18 | 40.0% | 5.00% | 55.00% | 1 | 75% | 97% | 2.00% | 1.00% | 6.3% |
| | graphene | | | | | hard | | | |
| | | | | | | carbon | | | |
| 19 | 40.0% | 5.00% | 55.00% | 1 | 95% | 97% | 2.00% | 1.00% | 5.1% |
| | graphene | | | | | hard | | | |
| | | | | | | carbon | | | |
| 20 | 40.0% | 5.00% | 55.00% | 1 | 90% | 97% | 2.00% | 1.00% | 11.4% |
| | graphene | | | | | natural | | | |
| | | | | | | graphite | | | |
| 21 | 40.0% | 5.00% | 55.00% | 1 | 90% | 97% | 2.00% | 1.00% | 14.3% |
| | graphene | | | | | oxide | | | |
| | | | | | | of silicon | | | |
| | | | | | | (SiOₓ, | | | |
| | | | | | | 0.5 ≤ x ≤ 1.5) | | | |

Comparative Embodiment

| | | | | | | | | | |
|---|---|---|---|---|---|---|---|---|---|
| 1 | 50.0% | 5.00% | 45.00% | 0.5 | 90% | 96% | 2.00% | 2.00% | 18.0% |
| | natural | | | | | hard | | | |
| | graphite | | | | | carbon | | | |
| 2 | 40.0% | 5.00% | 55.00% | 1 | 85% | 97% | 2.00% | 1.00% | 20.0% |
| | natural | | | | | hard | | | |
| | graphite | | | | | carbon | | | |
| 3 | / | / | / | / | / | 96% | 2.00% | 2.00% | 26.0% |
| | | | | | | hard | | | |
| | | | | | | carbon | | | |

As can be seen from comparison between Embodiments 1 to 21 and Comparative Embodiment 3, the cycle expansion rate of the electrochemical device is within 10% by virtue of the first coating layer, while the cycle expansion rate of the electrochemical device without the first coating layer is higher than 20%. Evidently, the first coating layer disposed between the second coating layer and the current collector significantly decreases the cycle expansion rate of the electrochemical device.

As can be seen from comparison between Embodiments 1 to 21 and Comparative Embodiments 1 to 2, when the mass percent of the conductive carbon material in the first coating layer is 20% to 60%, where the conductive carbon material includes at least one of carbon nanotubes or graphene, the cycle expansion rate of the electrochemical device is 5% to 15%. By contrast, in Comparative Embodiments 1 and 2, natural graphite is adopted in the first coating layer, and therefore, the cycle expansion rate of the electrochemical device is higher than 15%. The carbon nanotube or graphene serving as a conductive carbon material significantly decreases the cycle expansion rate of the electrochemical device.

As can be seen from comparison between Embodiments 1 to 3 and Embodiments 4 to 6, for the conductive carbon material itself, the mass percent of the conductive carbon material also affects the cycle expansion rate of the electrochemical device. With the increase of the mass percent of the conductive carbon material in the first coating layer, the cycle expansion rate of the electrochemical device shows a tendency to decrease first and then increase. That is because, when the mass percent of the conductive carbon material is excessively low, the conductive carbon material is unable to mitigate the damage caused by the active material, especially the hard carbon of a relatively high rigidity in the second coating layer, to the current collector. When the mass percent of the conductive carbon material is excessively high, the mass percent of the binder in the first coating layer will be not enough to firmly bond the first coating layer, with the result that the first coating layer is prone to expand.

As can be seen from comparison between Embodiments 8 to 10 and Embodiments 15 to 17, with the increase of the thickness of the first coating layer, the cycle expansion rate of the electrochemical device shows a tendency to decrease.

As can be seen from comparison between Embodiment 8 and Embodiments 11 to 12 as well as comparison between Embodiment 5 and Embodiments 18 to 19, with the increase of the coating rate of the first coating layer, the cycle expansion rate of the electrochemical device shows a tendency to decrease.

As can be seen from comparison between Embodiment 8 and Embodiments 13 to 14 as well as comparison between Embodiment 5 and Embodiments 20 to 21, the cycle expansion rate of the electrochemical device is affected by different types of negative active materials used in the second coating layer. The oxide of silicon used as a negative active material leads to a higher cycle expansion rate of the electrochemical device, and the hard carbon used as a negative active material leads to a lower cycle expansion rate of the electrochemical device.

What is described above is merely exemplary embodiments of this application and the technical principles thereof. A person skilled in the art understands that the scope of disclosure in this application is not limited to the technical solutions formed by a specific combination of the foregoing technical features, but also covers other technical solutions formed by arbitrarily combining the foregoing technical features or equivalents thereof, for example, a technical solution formed by replacing any of the foregoing features with a technical feature disclosed herein and serving similar functions.

What is claimed is:

1. An electrochemical device, comprising a negative electrode sheet, wherein the negative electrode sheet comprises:
a current collector;
a first coating layer and a second coating layer that are disposed on a surface of the current collector, wherein the first coating layer is located between the current collector and the second coating layer;
the first coating layer comprises a conductive carbon material, the conductive carbon material comprises at least one of carbon nanotubes or graphene; and based on a mass of the first coating layer, a mass percent of the conductive carbon material is 20% to 60%; and
the second coating layer comprises a negative active material.

2. The electrochemical device according to claim 1, wherein the negative active material comprises at least one of hard carbon, artificial graphite, natural graphite, or oxide of silicon.

3. The electrochemical device according to claim 1, wherein a thickness of the first coating layer is 0.3 μm to 2 μm.

4. The electrochemical device according to claim 1, wherein a coating rate of the first coating layer is greater than or equal to 60%.

5. The electrochemical device according to claim 1, wherein the first coating layer and the second coating layer each further comprise a dispersant; and the dispersant comprises at least one of carboxymethyl cellulose salt, polyacrylic acid sodium salt, polyethylene glycol, or polyethylene oxide.

6. The electrochemical device according to claim 5, wherein based on the mass of the first coating layer, a mass percent of the dispersant in the first coating layer is 1% to 10%, and/or, based on a mass of the second coating layer, a mass percent of the dispersant in the second coating layer is 1% to 10%.

7. The electrochemical device according to claim 1, wherein the first coating layer and the second coating layer each further comprise a binder; and the binder comprises at least one of polyvinylidene fluoride, polyvinylidene difluoride, poly(vinylidene difluoride-co-hexafluoropropylene), styrene-butadiene rubber, styrene-acrylic latex, sodium carboxymethyl cellulose, polyacrylic acid sodium salt, polyethylene oxide, or polyvinyl alcohol.

8. The electrochemical device according to claim 7, wherein, based on the mass of the first coating layer, a mass percent of the binder in the first coating layer is 35% to 75%, and/or, based on a mass of the second coating layer, a mass percent of the binder in the second coating layer is 1% to 10%.

9. The electrochemical device according to claim 2, wherein the negative active material is hard carbon, and, based on a mass of the second coating layer, amass percent of the hard carbon is 95% to 99%.

10. An electronic device, comprising an electrochemical device, wherein the electrochemical device comprising a negative electrode sheet, wherein the negative electrode sheet comprises:
a current collector;
a first coating layer and a second coating layer that are disposed on a surface of the current collector, wherein the first coating layer is located between the current collector and the second coating layer;
the first coating layer comprises a conductive carbon material, the conductive carbon material comprises at least one of carbon nanotubes or graphene, and, based on a mass of the first coating layer, a mass percent of the conductive carbon material is 20% to 60%; and
the second coating layer comprises a negative active material.

11. The electronic device according to claim 10, wherein the negative active material comprises at least one of hard carbon, artificial graphite, natural graphite, or oxide of silicon.

12. The electronic device according to claim 10, wherein a thickness of the first coating layer is 0.3 μm to 2 μm.

13. The electronic device according to claim 10, wherein a coating rate of the first coating layer is greater than or equal to 60%.

14. The electronic device according to claim 10, wherein the first coating layer and the second coating layer each further comprise a dispersant; and the dispersant comprises at least one of carboxymethyl cellulose salt, polyacrylic acid sodium salt, polyethylene glycol, or polyethylene oxide.

15. The electronic device according to claim 10, wherein based on the mass of the first coating layer, a mass percent of the dispersant is 1% to 10%, and/or, based on a mass of the second coating layer, a mass percent of the dispersant is 1% to 10%.

16. The electronic device according to claim 10, wherein the first coating layer and the second coating layer each further comprise a binder; and the binder comprises at least one of polyvinylidene fluoride, polyvinylidene difluoride, poly(vinylidene difluoride-co-hexafluoropropylene), styrene-butadiene rubber, styrene-acrylic latex, sodium carboxymethyl cellulose, polyacrylic acid sodium salt, polyethylene oxide, or polyvinyl alcohol.

17. The electronic device according to claim 10, wherein, based on the mass of the first coating layer, a mass percent of the binder is 35% to 75%, and/or, based on a mass of the second coating layer, a mass percent of the binder is 1% to 10%.

18. The electronic device according to claim 10, wherein the negative active material is hard carbon, and, based on a mass of the second coating layer, amass percent of the hard carbon is 95% to 99%.
